(19) United States
(12) Patent Application Publication
(10) Pub. No.: US 2024/0361817 A1
(43) Pub. Date: Oct. 31, 2024

(54) POWER SUPPLY CONTROL DEVICE AND POWER SUPPLY CONTROL METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Kazutaka NAITO, Yokkaichi-shi, Mie (JP); Kota ODA, Yokkaichi-shi, Mie (JP)

(21) Appl. No.: 18/560,799

(22) PCT Filed: Mar. 28, 2022
(86) PCT No.: PCT/JP2022/014839

§ 371 Date: Nov. 14, 2023

(30) Foreign Application Priority Data
May 25, 2021 (JP) 2021-087592

(51) Int. Cl. G06F 1/26; B60R 16/03; H02H 7/22; H02J 1/00

(52) U.S. Cl. CPC G06F 1/26; H02H 7/22; B60R 16/03; H02J 1/00

(57) ABSTRACT

A power supply control device controls power supplied via a power supply switch. A backup circuit instructs an IPD to turn the power supply switch on or off, based on an instruction signal instructing to turn the power supply switch on or off. A MICOM transmits an ON signal instructing to turn on the power supply switch and an OFF signal instructing to turn off the power supply switch to the IPD via a communication line (Lc). The MICOM determines whether communication via the communication line (Lc) is interrupted. The MICOM, in the case of determining that communication is interrupted, causes the backup circuit to start instructing to turn the power supply switch on or off.

### CROSS-REFERENCE TO RELATED APPLICATIONS

This application is the U.S. national stage of PCT/JP2022/014839 filed on Mar. 28, 2022, which claims priority of Japanese Patent Application No. JP 2021-087592 filed on May 25, 2021, the contents of which are incorporated herein.

### TECHNICAL FIELD

The present disclosure relates to a power supply control device and a power supply control method.

### BACKGROUND

JP 2009-23421A discloses a power supply control device that controls power supply from a power source to a load. A switch is disposed on a power supply path from the power source to the load. A microcomputer (hereinafter, MICOM) transmits a control signal instructing to turn the switch on or off. The switch is turned on or off, in accordance with the control signal transmitted by the MICOM. Power supply is thereby controlled.

In JP 2009-23421A, a MICOM transmits a control signal via a communication line. However, interruption of communication via the communication line is not taken into consideration. If communication is interrupted, the switch cannot be turned on or off.

In view of this, an object is to provide a power supply control device and a power supply control method that are able to turn a switch on or off, even if communication is interrupted.

### SUMMARY

A power supply control device according to one mode of the present disclosure is a power supply control device for controlling power supplied via a power supply switch, including a switcher configured to turn the power supply switch on or off, an instruction circuit configured to instruct the switcher to turn the power supply switch on or off, based on an instruction signal instructing to turn the power supply switch on or off, a communication unit configured to transmit an ON signal instructing to turn on the power supply switch and an OFF signal instructing to turn off the power supply switch to the switcher via a communication line, and a processing unit configured to execute processing, the processing unit instructing the communication unit to transmit the ON signal or the OFF signal, based on the instruction signal, determining whether communication via the communication line is interrupted, and, in a case of determining that the interruption has occurred, causing the instruction circuit to start instructing to turn the power supply switch on or off.

A power supply control method according to one mode of the present disclosure is a power supply control method of a power supply control device for controlling power supplied via a power supply switch for use in controlling power supply and including a switcher configured to turn the power supply switch on or off, an instruction circuit configured to instruct the switcher to turn the power supply switch on or off based on an instruction signal instructing to turn the power supply switch on or off, and a communication unit configured to transmit an ON signal instructing to turn on the power supply switch and an OFF signal instructing to turn off the power supply switch to the switcher via a communication line, the power supply control method using a computer to execute instructing the communication unit to transmit the ON signal or the OFF signal, based on the instruction signal, determining whether communication via the communication line is interrupted, and, in a case of determining that the interruption has occurred, causing the instruction circuit to start instructing to turn the power supply switch on or off.

Note that the present disclosure can be realized not only as a power supply control device that executes characteristic processing such as the above but also as a power supply control method having characteristic processing such as the above as steps, or as a computer program for causing a computer to execute such steps. Also, the present disclosure can be realized as a semiconductor integrated circuit that realizes part or all of the power supply control device, or as a power system that includes the power supply control device.

### Advantageous Effects

According to the present disclosure, a switch can be turned on or off, even if communication is interrupted.

### BRIEF DESCRIPTION OF DRAWINGS

FIG. 1 is a block diagram showing the configuration of a main section of a power system according to Embodiment 1.

FIG. 2 is a plan view of a power supply control device.

FIG. 3 is a block diagram showing the configuration of a main section of an IPD.

FIG. 4 is a flowchart showing the procedure of flag change processing.

FIG. 5 is a flowchart showing the procedure of switch processing.

FIG. 6 is a block diagram showing the configuration of a main section of a MICOM.

FIG. 7 is a flowchart showing the procedure of transmission processing.

FIG. 8 is a flowchart showing the procedure of interruption detection processing.

FIG. 9 is a circuit diagram of a backup circuit.

FIG. 10 is a chart showing operations of the backup circuit.

FIG. 11 is a timing chart showing a first example of operations performed by the power supply control device.

FIG. 12 is a timing chart showing a second example of operations performed by the power supply control device.

FIG. 13 is a block diagram showing the configuration of a main section of a power supply control device according to Embodiment 2.

FIG. 14 is a block diagram showing the configuration of a main section of a MICOM.

FIG. 15 is a flowchart showing the procedure of second interruption detection processing.

### DETAILED DESCRIPTION OF PREFERRED EMBODIMENTS

Initially, modes of the present disclosure will be enumerated and described. At least some of the embodiments described below may be freely combined.

A power supply control device according to one mode of the present disclosure is a power supply control device for controlling power supplied via a power supply switch, including a switcher configured to turn the power supply switch on or off, an instruction circuit configured to instruct the switcher to turn the power supply switch on or off, based on an instruction signal instructing to turn the power supply switch on or off, a communication unit configured to transmit an ON signal instructing to turn on the power supply switch and an OFF signal instructing to turn off the power supply switch to the switcher via a communication line, and a processing unit configured to execute processing, the processing unit instructing the communication unit to transmit the ON signal or the OFF signal, based on the instruction signal, determining whether communication via the communication line is interrupted, and, in a case of determining that the interruption has occurred, causing the instruction circuit to start instructing to turn the power supply switch on or off.

The power supply control device according to one mode of the present disclosure may further include an operation determination unit configured to determine whether the processing unit has stopped operating, and the operation determination unit, in the case of determining that the processing unit has stopped operating, may cause the instruction circuit to start instructing to turn the power supply switch on or off.

In the power supply control device according to one mode of the present disclosure, the processing unit may acquire a value of a switch current flowing through the power supply switch, and, if the acquired value of the switch current is less than a predetermined current value despite the communication unit being instructed to transmit the ON signal, may determine that the interruption has occurred.

In the power supply control device according to one mode of the present disclosure, the processing unit may acquire a value of a switch current flowing through the power supply switch, and, if the acquired value of the switch current is greater than or equal to a second predetermined current value despite the communication unit being instructed to transmit the OFF signal, may determine that the interruption has occurred.

The power supply control device according to one mode of the present disclosure may further include a voltage detection unit configured to detect a voltage of the communication line, the communication unit may be disposed on a first board, the switcher and part of the communication line may be disposed on a second board, the voltage detection unit may detect the voltage of the communication line disposed on the second board, and the processing unit may determine whether the interruption has occurred, based on the voltage of the communication line detected by the voltage detection unit.

A power supply control method according to one mode of the present disclosure is a power supply control method of a power supply control device for controlling power supplied via a power supply switch for use in controlling power supply and including a switcher configured to turn the power supply switch on or off, an instruction circuit configured to instruct the switcher to turn the power supply switch on or off based on an instruction signal instructing to turn the power supply switch on or off, and a communication unit configured to transmit an ON signal instructing to turn on the power supply switch and an OFF signal instructing to turn off the power supply switch to the switcher via a communication line, the power supply control method using a computer to execute instructing the communication unit to transmit the ON signal or the OFF signal, based on the instruction signal, determining whether communication via the communication line is interrupted, and, in a case of determining that the interruption has occurred, causing the instruction circuit to start instructing to turn the power supply switch on or off.

With the power supply control device and the power supply control method according to the above modes, when an instruction signal instructing to turn on the power supply switch is input, the communication unit transmits the ON signal to the switcher via the communication line. The switcher thereby turns on the power supply switch. When an instruction signal instructing to turn off the power supply switch is input, the communication unit transmits the OFF signal to the switcher via the communication line. The switcher thereby turns off the power supply switch. If the processing unit determines that communication is interrupted, the instruction circuit instructs the switcher to turn the power supply switch on or off, based on the instruction signal. Accordingly, even if communication is interrupted, the power supply switch turns on or off, based on the instruction signal.

With the power supply control device according to the above modes, when the processing unit stops operating, the instruction circuit instructs the switcher to turn the power supply switch on or off, based on the instruction signal. Accordingly, even when operation of the processing unit stops, the power supply switch can be turned on or off, based on the instruction signal.

With the power supply control device according to the above modes, the processing unit detects interruption of communication, when the switch current is small despite the processing unit instructing the communication unit to transmit the ON signal.

With the power supply control device according to the above modes, the processing unit detects interruption of communication, when the switch current is large despite the processing unit instructing the communication unit to transmit the OFF signal.

With the power supply control device according to the above modes, if the voltage of the communication line does not match the voltage of the signal transmitted by the communication unit, the processing unit detects interruption of communication.

Specific examples of a power system according to embodiments of the present disclosure will be described below with reference to the drawings. Note that the present disclosure is not limited to these illustrative examples and is indicated by the claims, and all changes that come within the meaning and range of equivalency of the claims are intended to be embraced therein.

### Embodiment 1

### Configuration of Power System 1

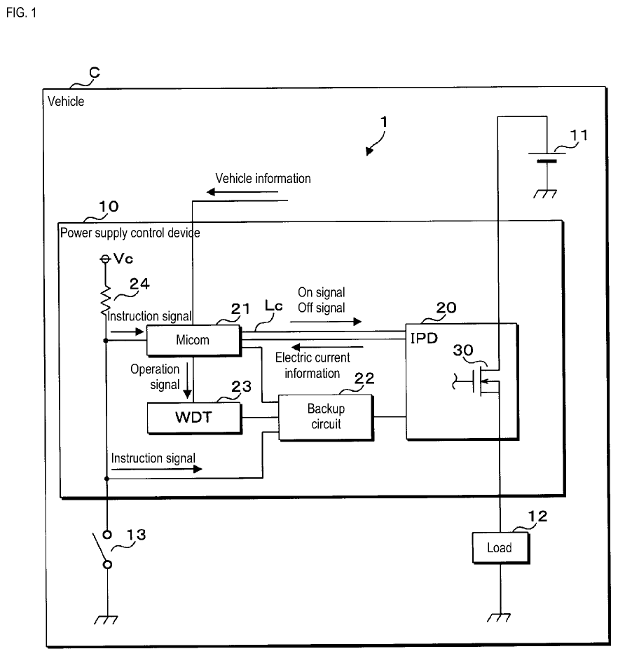

FIG. 1 is a block diagram showing the configuration of a main section of a power system 1 according to Embodiment 1. The power system 1 is installed in a vehicle C. The power system 1 includes a power supply control device 10, a DC (Direct Current) power source 11 and a load 12. The DC power source 11 is a battery, for example. The load 12 is an electrical device. When power is supplied to the load 12, the load 12 operates. When power supply to the load 12 stops, the load 12 stops operating.

The power supply control device 10 includes a power supply switch 30. The power supply switch 30 is an N-channel FET (Field Effect Transistor). When the power supply switch 30 is on, the resistance value between the drain and source of the power supply switch 30 is sufficiently small. It is thus possible for a current to flow through the drain and source of the power supply switch 30. When the power supply switch 30 is off, the resistance value between the drain and source of the power supply switch 30 is sufficiently large. Thus, a current does not flow through the drain and source of the power supply switch 30.

The drain of the power supply switch 30 is connected to a positive electrode of the DC power source 11. The source of the power supply switch 30 is connected to one end of the load 12. A negative electrode of the DC power source 11 and the other end of the load 12 are grounded. Grounding is realized by connection to the body of the vehicle C, for example.

One end of the operating switch 13 is connected to the power supply control device 10. The other end of the operating switch 13 is grounded. The operating switch 13 is operated by an occupant of the vehicle C. Vehicle information relating to the vehicle C is input to the power supply control device 10. The vehicle information indicates the speed of the vehicle C, the acceleration of the vehicle C, the brightness around the vehicle C or the like. The power supply control device 10 turns the power supply switch 30 on or off, based on the state of the operating switch 13 and the input vehicle information.

When the power supply switch 30 turns on, a current flows in order of the power supply switch 30 and the load 12 from the positive electrode of the DC power source 11, and power is supplied to the load 12. As a result, the load 12 operates. When the power supply switch 30 turns off, power supply to the load 12 via the power supply switch 30 stops. As a result, the load 12 stops operating. The power supply control device 10 controls power supplied via the power supply switch 30, by turning the power supply switch 30 on or off. The power supply switch 30 is used to control power supply from the DC power source 11 to the load 12.

### Configuration of Power Supply Control Device 10

The power supply control device 10 includes an IPD (Intelligent Power Device) 20, a microcomputer (hereinafter, MICOM) 21, a backup circuit 22, a watchdog timer (hereinafter, WDT) 23, and a device resistor 24. The IPD 20 includes the power supply switch 30. The IPD 20 is connected to the MICOM 21 by a communication line Lc and a connection line different from the communication line Lc. The IPD 20 is, furthermore, connected to the backup circuit 22. The MICOM 21 is, furthermore, separately connected to the backup circuit 22 and the WDT 23. The WDT 23 is further connected to the backup circuit 22.

A constant voltage Vc is applied to one end of the device resistor 24. The constant voltage Vc is generated by a regulator not shown stepping down the end-to-end voltage of the DC power source 11, for example. The other end of the device resistor 24 is connected to one end of the operating switch 13. As aforementioned, the other end of the operating switch 13 is grounded. The connection node between the operating switch 13 and the device resistor 24 is connected to the MICOM 21 and the backup circuit 22.

The MICOM 21 transmits an ON signal instructing to turn on the power supply switch 30 and an OFF signal instructing to turn off the power supply switch 30 to the IPD 20. The IPD 20 stores the value of the communication flag. The IPD 20, in the case of receiving the ON signal, changes the value of the communication flag to 1. The IPD 20, in the case of receiving the OFF signal, changes the value of the communication flag to zero.

The backup circuit 22 outputs a high level voltage or a low level voltage to the IPD 20. The high level voltage is a voltage greater than or equal to a fixed voltage threshold. The low level voltage is a voltage less than the voltage threshold.

The IPD 20 turns on the power supply switch 30, in response to the value of the communication flag being changed from zero to 1, or the output voltage of the backup circuit 22 switching from the low level voltage to the high level voltage. The IPD 20 turns off the power supply switch 30, in response to the value of the communication flag being changed from 1 to zero while the output voltage of the backup circuit 22 is the low level voltage. The IPD 20, furthermore, turns off the power supply switch 30, in response to the output voltage of the backup circuit 22 switching from the high level voltage to the low level voltage while the value of the communication flag is zero.

The IPD 20 changes the value of the communication flag to zero, in the case of a non-reception time period for which a signal has not been received from the MICOM 21 becoming greater than or equal to a fixed predetermined time period. When the IPD 20 receives a signal from the MICOM 21, the non-reception time period is reset to zero. The IPD 20 outputs, to the MICOM 21, analog electric current information indicating a switch current that flows through the power supply switch 30. The electric current information is a voltage proportional to the switch current that flows through the power supply switch 30.

An instruction signal instructing to turn the power supply switch 30 on or off is input to the MICOM 21 and the backup circuit 22 from the connection node between the operating switch 13 and the device resistor 24. The instruction signal shows the high level voltage or the low level voltage. The constant voltage Vc is the high level voltage. Zero V is the low level voltage.

The occupant of the vehicle C gives an instruction to turn on the power supply switch 30, by turning on the operating switch 13. When the operating switch 13 is on, zero V, that is, the low level voltage, is output to the MICOM 21 and the backup circuit 22 as the instruction signal. The occupant of the vehicle C gives an instruction to turn off the power supply switch 30, by turning off the operating switch 13. When the operating switch 13 is off, a constant voltage Vc, that is, the high level voltage, is output to the MICOM 21 and the backup circuit 22 as the instruction signal.

The MICOM 21 transmits the ON signal or the OFF signal to the IPD 20 via the communication line Lc, based on the instruction signal and the vehicle information. The MICOM 21 determines whether communication via the communication line Lc is interrupted, based on the input electric current information. The MICOM 21 outputs the high level voltage or the low level voltage to the backup circuit 22. The MICOM 21 normally outputs the low level voltage to the backup circuit 22. The MICOM 21, in the case of determining that communication is interrupted, switches the output voltage being output to the backup circuit 22 from the low level voltage to the high level voltage.

The MICOM 21 periodically outputs an operation signal indicating that the MICOM 21 is operating to the WDT 23. The WDT 23 measures a non-input time period for which the operation signal has not been input. When the operation signal is input to the WDT 23, the non-input time period is reset to zero. The WDT 23 outputs the high level voltage or the low level voltage to the backup circuit 22. The WDT 23 normally outputs the high level voltage. When the non-input time period is greater than or equal to a fixed time period threshold, the WDT 23 switches the output voltage being output to the backup circuit 22 to the low level voltage.

As described above, the WDT 23 determines whether the MICOM 21 has stopped operating, based on whether the non-input time period is greater than or equal to the time period threshold. The WDT 23 determines that the MICOM 21 has stopped operating, when the non-input time period becomes greater than or equal to the time period threshold.

When the MICOM 21 and the WDT 23 are respectively outputting the low level voltage and the high level voltage to the backup circuit 22, the backup circuit 22 outputs the low level voltage to the IPD 20 regardless of the voltage shown by the instruction signal. When the instruction signal is instructing to turn on the power supply switch 30 in the case where the MICOM 21 is outputting the high level voltage to the backup circuit 22 or the WDT 23 is outputting the low level voltage to the backup circuit 22, the backup circuit 22 outputs the high level voltage. When the instruction signal is instructing to turn off the power supply switch 30 in the same case, the backup circuit 22 outputs the low level voltage.

As is clear from the above, when communication is not interrupted and the MICOM 21 has not stopped operating, the backup circuit 22 outputs the low level voltage to the IPD 20. The IPD 20 thus turns the power supply switch 30 on or off according to the signal that is input from the MICOM 21.

If communication is interrupted or the MICOM 21 stops operating, the non-reception time period for the IPD 20 becomes greater than or equal to a predetermined time period, and the IPD 20 changes the value of the communication flag to zero. If communication is interrupted or the MICOM 21 stops operating, the backup circuit 22 outputs, to the IPD 20, a voltage that depends on the instruction of the instruction signal. The IPD 20 turns the power supply switch 30 on or off according to the output voltage of the backup circuit 22.

Hereinafter, the operations of the IPD 20, the MICOM 21 and the backup circuit 22 will be described in detail.

### Outward Appearance of Power Supply Control Device 10

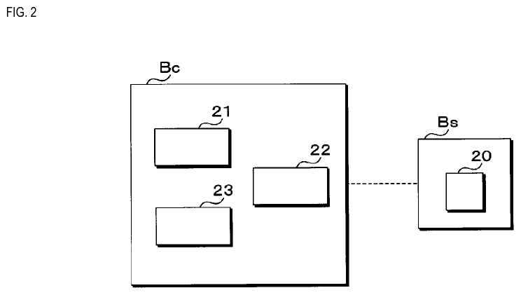

FIG. 2 is a plan view of the power supply control device 10. The power supply control device 10 further includes a control board Bc and a switch board Bs. The control board Bc and the switch board Bs each have a rectangular shape. The IPD 20 is disposed on a main surface of the switch board Bs. The main surfaces of the boards have a large surface area and differ from the end faces. The MICOM 21, the backup circuit 22 and the WDT 23 are disposed on the main surface of the control board Bc. The switch board Bs and the control board Bc are coupled by the communication line Lc, the connection line and the like. Part of the communication line Lc is disposed on the main surface of both the switch board Bs and the control board Bc.

### Configuration of IPD 20

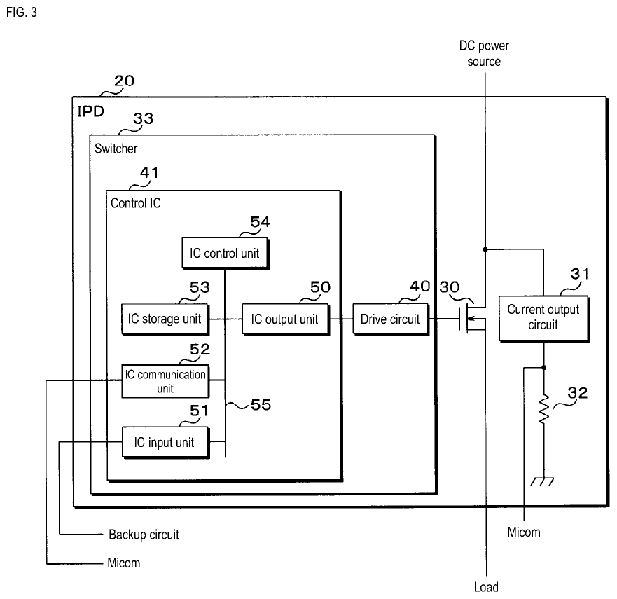

FIG. 3 is a block diagram showing the configuration of a main section of the IPD 20. The IPD 20 includes a current output circuit 31, a detection resistor 32 and a switcher 33, in addition to the power supply switch 30. Accordingly, the switcher 33 is disposed on the switch board Bs, and the switch board Bs functions as a second board. The switcher 33 includes a drive circuit 40 and a control IC 41.

IC is short for integrated circuit. The control IC 41 includes an IC output unit 50, an IC input unit 51, an IC communication unit 52, an IC storage unit 53 and an IC control unit 54.

The drain of the power supply switch 30 is, furthermore, connected to the current output circuit 31. The current output circuit 31 is, furthermore, connected to one end of the detection resistor 32. The other end of the detection resistor 32 is grounded. The connection node between the current output circuit 31 and the detection resistor 32 is connected to the MICOM 21.

The gate of the power supply switch 30 is connected to the drive circuit 40 of the switcher 33. The drive circuit 40 is, furthermore, connected to the IC output unit 50 of the control IC 41. The IC output unit 50, the IC input unit 51, the IC communication unit 52, the IC storage unit 53 and the IC control unit 54 are connected to an IC bus 55. The IC input unit 51 is, furthermore, connected to the backup circuit 22. The IC communication unit 52 is, furthermore, connected to the MICOM 21.

The current output circuit 31 draws a current proportional to the switch current that flows through the power supply switch 30, and outputs the drawn current to the detection resistor 32. The current that the current output circuit 31 outputs to the detection resistor 32 is represented by (switch current)/(predetermined number). The predetermined number is 1000, for example. The end-to-end voltage of the detection resistor 32 is output to the MICOM 21 as analog electric current information. The analog electric current information is represented by (switch current) (resistance value of detection resistor 32)/(predetermined number). The “.” sign represents product. Since the resistance value of the detection resistor 32 and the predetermined number are fixed values, the electric current information indicates the switch current.

When the voltage of the gate of the power supply switch 30 relative to the potential of the source is greater than or equal to a fixed ON threshold, the power supply switch 30 is on. When the voltage of the gate relative to the potential of the source is less than a fixed OFF threshold, the power supply switch 30 is off. The ON threshold is greater than or equal to the OFF threshold.

The IC output unit 50 outputs the high level voltage or the low level voltage to the drive circuit 40. The IC output unit 50 switches the output voltage being output to the drive circuit 40 to the high level voltage or the low level voltage, in accordance with the instruction from the IC control unit 54. When the IC output unit 50 switches the output voltage from the low level voltage to the high level voltage, the drive circuit 40 raises the voltage of the gate relative to ground potential. The voltage of the gate relative to the potential of the source thereby rises to a voltage greater than or equal to the ON threshold, and the power supply switch 30 turns on.

When the IC output unit 50 switches the output voltage from the high level voltage to the low level voltage, the drive circuit 40 lowers the voltage of the gate relative to ground potential. The voltage of the gate relative to the potential of the source thereby falls to a voltage less than the OFF threshold, and the power supply switch 30 turns off. As described above, the drive circuit 40 of the switcher 33 turns the power supply switch 30 on or off, according to the output voltage of the IC output unit 50.

The backup circuit 22 outputs the high level voltage or the low level voltage to the IC input unit 51. The IC communication unit 52 receives the ON signal and the OFF signal from the MICOM 21. The IC storage unit 53 includes a non-volatile memory and a volatile memory, for example. The IC storage unit 53 stores the value of the communication flag. The value of the communication flag is changed by the IC control unit 54.

The IC storage unit 53 stores a computer program. The IC control unit 54 includes a processing element that executes processing, such as a CPU (Central Processing Unit), for example. The processing element of the IC control unit 54 executes flag change processing, switch processing and the like by executing the computer program. The flag change processing is processing for changing the value of the communication flag. The switch processing is processing for turning the power supply switch 30 on or off. The IC control unit 54 may include two or more processing elements. In this case, a plurality of processing elements may jointly execute the flag change processing, switch processing and the like.

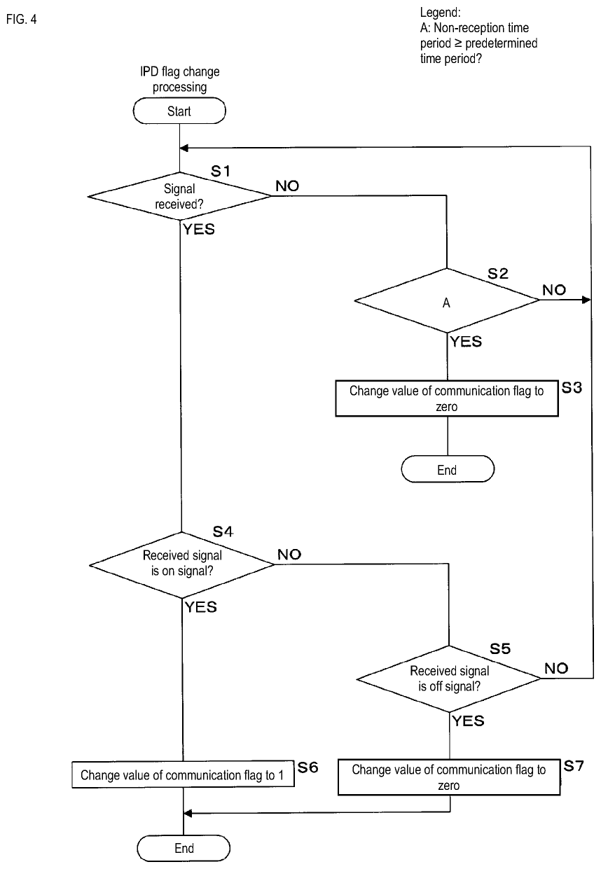

FIG. 4 is a flowchart showing the procedure of flag change processing. The MICOM 21 is not limited to transmitting the ON signal and the OFF signal, and also transmits signals other than the ON signal and the OFF signal to the IC communication unit 52 of the control IC 41. As long as communication via the communication line LC is not interrupted and the MICOM 21 does not stop operating, the MICOM 21 is configured to transmit a signal to the IC communication unit 52, and then transmit the next signal before a predetermined time period elapses.

In the flag change processing, the IC control unit 54 determines whether the IC communication unit 52 has received a signal (step S1). The IC control unit 54, in the case of determining that the IC communication unit 52 has not received a signal (S1: NO), determines whether the non-reception time period is greater than or equal to a predetermined time period (step S2). As aforementioned, the non-reception time period is a period for which the IC communication unit 52 has not received a signal from the MICOM 21. The IC control unit 54, in the case of determining that the non-reception time period is less than the predetermined time period (S2: NO), executes step S1. The IC control unit 54 waits until the IC communication unit 52 receives a signal from the MICOM 21 or the non-reception time period becomes greater than or equal to the predetermined time period.

The IC control unit 54, in the case of determining that the non-reception time period is greater than or equal to the predetermined time period (S2: YES), changes the value of the communication flag to zero (step S3). After executing step S3, the IC control unit 54 executes the flag change processing again.

The IC control unit 54, in the case of determining that the IC communication unit 52 has received a signal from the MICOM 21 (S1: YES), determines whether the signal received by the IC communication unit 52 is the ON signal (step S4). The IC control unit 54, in the case of determining that the received signal is not the ON signal (S4: NO), determines whether the received signal is the OFF signal (step S5). The IC control unit 54, in the case of determining that the received signal is not the OFF signal (S5: NO), executes step S1. The IC control unit 54 again waits until the IC communication unit 52 receives a signal from the MICOM 21 or the non-reception time period becomes greater than or equal to the predetermined time period.

The IC control unit 54, in the case of determining that the received signal is the ON signal (S4: YES), changes the value of the communication flag to 1 (step S6). The IC control unit 54, in the case of determining that the received signal is the OFF signal (S5: YES), changes the value of the communication flag to zero (step S7). After executing one of steps S6 and S7, the IC control unit 54 ends the flag change processing. After ending the flag change processing, the IC control unit 54 executes the flag change processing again.

As described above, the IC control unit 54 of the control IC 41 changes the value of the communication flag to 1, when the IC communication unit 52 receives the ON signal. The IC control unit 54 changes the value of the communication flag to zero, when the IC communication unit 52 receives the OFF signal. In the case where the non-reception time period becomes greater than or equal to the predetermined time period, the IC control unit 54 changes the value of the communication flag to zero.

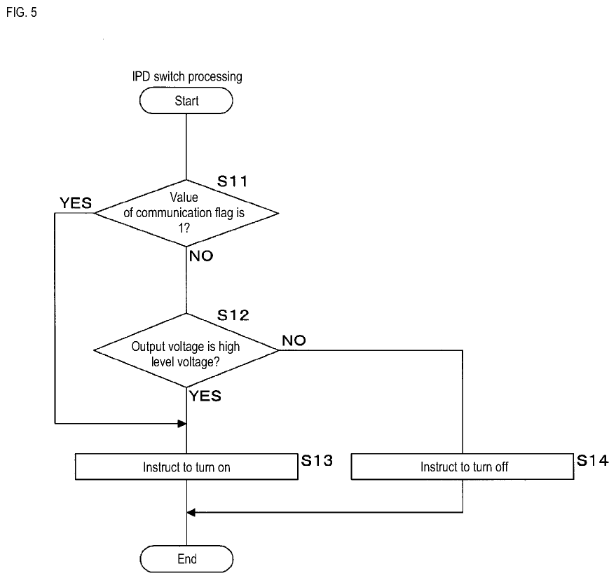

FIG. 5 is a flowchart showing the procedure of switch processing. In the switch processing, the IC control unit 54 determines whether the value of the communication flag is 1 (step S11). If the value of the communication flag is not 1, the value of the communication flag is zero. The IC control unit 54, in the case of determining that the value of the communication flag is not 1 (S11: NO), determines whether the output voltage being output to the IC input unit 51 by the backup circuit 22 is the high level voltage (step S12). When the output voltage of the backup circuit 22 is not the high level voltage, the output voltage of the backup circuit 22 is the low level voltage.

The IC control unit 54, in the case of determining that the value of the communication flag is 1 (S11: YES), or that the output voltage being output by the backup circuit 22 is the high level voltage (S12: YES), gives an instruction to the IC output unit 50 to turn on the power supply switch 30 (step S13). The IC output unit 50 thereby switches the output voltage being output to the drive circuit 40 to the high level voltage. The drive circuit 40 turns on the power supply switch 30.

The IC control unit 54, in the case of determining that the output voltage being output by the backup circuit 22 is not the high level voltage (S12: NO), gives an instruction to the IC output unit 50 to turn off the power supply switch 30 (step S14). The IC output unit 50 thereby switches the output voltage being output to the drive circuit 40 to the low level voltage. The drive circuit 40 turns off the power supply switch 30. After executing one of steps S13 and S14, the IC control unit 54 ends the switch processing. After ending the switch processing, the IC control unit 54 executes the switch processing again.

As described above, in response to the value of the communication flag being changed from zero to 1, or the output voltage of the backup circuit 22 switching from the low level voltage to the high level voltage, the drive circuit 40 turns on the power supply switch 30. In response to the value of the communication flag being changed from 1 to zero while the output voltage of the backup circuit 22 is the low level voltage, the drive circuit 40 turns off the power supply switch 30. In response to the output voltage of the backup circuit 22 switching from the high level voltage to the low level voltage while the value of the communication flag is zero, the drive circuit 40 turns off the power supply switch 30.

### Configuration of MICOM 21

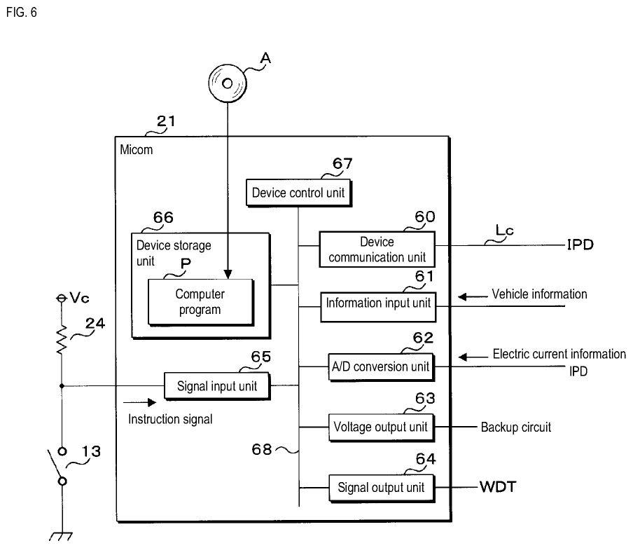

FIG. 6 is a block diagram showing the configuration of a main section of the MICOM 21. The MICOM 21 includes a device communication unit 60, an information input unit 61, an A/D conversion unit 62, a voltage output unit 63, a signal output unit 64, a signal input unit 65, a device storage unit 66 and a device control unit 67. These components are connected to a device bus 68. The device communication unit 60 is, furthermore, connected to the communication line Lc. The A/D conversion unit 62 is, furthermore, connected to the connection node between the current output circuit 31 and detection resistor 32 provided in the IPD 20. The voltage output unit 63 is, furthermore, connected to the backup circuit 22. The signal output unit 64 is, furthermore, connected to the WDT 23. The signal input unit 65 is connected to the connection node between the device resistor 24 and the operating switch 13.

As aforementioned, the MICOM 21 is disposed on the main surface of the control board Bc. The device communication unit 60 is thus disposed on the main surface of the control board Bc. The control board Bc functions as a first board. The device communication unit 60 transmits the ON signal, the OFF signal and the like to the IC communication unit 52 of the switcher 33 provided in the IPD 20 via the communication line Lc, in accordance with the instruction from the device control unit 67. Vehicle information is input to the information input unit 61. Analog electric current information is input to the A/D conversion unit 62 from the IPD 20. The A/D conversion unit 62 converts the input analog electric current information into digital electric current information. The digital electric current information obtained through conversion by the A/D conversion unit 62 is acquired by the device control unit 67.

The voltage output unit 63 outputs the high level voltage or the low level voltage to the backup circuit 22. The voltage output unit 63 switches the output voltage to the high level voltage or the low level voltage, in accordance with the instruction from the device control unit 67. The signal output unit 64 periodically outputs an operation signal to the WDT 23, in accordance with the instruction from the device control unit 67. An instruction signal is input to the signal input unit 65.

The device storage unit 66 includes a non-volatile memory and a volatile memory, for example. The device storage unit 66 stores a computer program P. The device control unit 67 includes a processing element that executes processing, such as a CPU, for example. The device control unit 67 functions as a processing unit. The processing element (computer) of the device control unit 67 executes output processing, transmission processing and interruption detection processing by executing the computer program P. The output processing is processing for periodically outputting the operation signal to the WDT 23. The transmission processing is processing for transmitting the ON signal or the OFF signal to the IC communication unit 52 of the IPD 20. The interruption detection processing is processing for detecting interruption of communication via the communication line Lc.

When the device control unit 67 stops operating, the MICOM 21 stops operating. Operation of the device control unit 67 stopping is equivalent to operation of the MICOM 21 stopping. As aforementioned, the WDT 23 determines whether the MICOM 21 has stopped operating. The WDT 23 functions as an operation determination unit.

Note that the computer program P may be provided to the MICOM 21 using a non-transitory storage medium A in which the computer program P is stored in a readable manner. The storage medium A is a portable memory, for example. In the case where the storage medium A is a portable memory, the processing element of the device control unit 67 may read the computer program P from the storage medium A using a reading device not shown. The read computer program P is written to the device storage unit 66. Furthermore, the computer program P may be provided to the MICOM 21, by a communication unit not shown of the MICOM 21 communicating with an external device. In this case, the processing element of the device control unit 67 acquires the computer program P through the communication unit. The acquired computer program P is written to the device storage unit 66. The device control unit 67 may include two or more processing elements. In this case, a plurality of processing elements may jointly execute the output processing, transmission processing, interruption detection processing and the like.

In the output processing, the device control unit 67 instructs the signal output unit 64 to output the operation signal to the WDT 23, every time one period elapses.

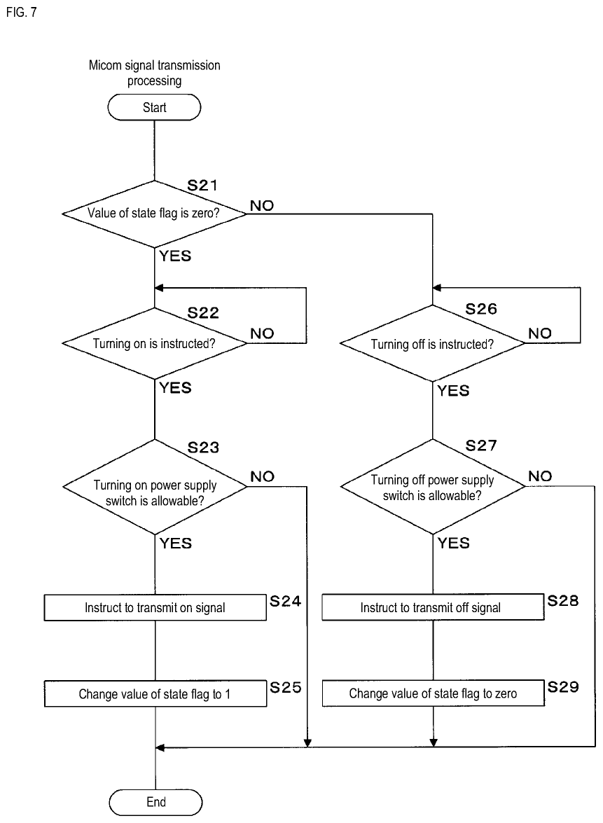

FIG. 7 is a flowchart showing the procedure of transmission processing. The device storage unit 66 stores the value of a state flag. The device control unit 67 changes the value of the state flag to zero or 1. As will be described in the description of the transmission processing, when the device communication unit 60 transmits the ON signal, the value of the state flag is changed to 1. When the device communication unit 60 transmits the OFF signal, the value of the state flag is changed to zero. The device control unit 67 executes transmission processing while the backup circuit 22 is outputting the low level voltage to the IC input unit 51 of the IPD 20.

In the transmission processing, the device control unit 67, first, determines whether the value of the state flag is zero (step S21). If the value of the state flag is not zero, the value of the state flag is 1. The device control unit 67, in the case of determining that the value of the state flag is zero (S21: YES), determines whether turning on the power supply switch 30 is being instructed by the instruction signal (step S22). When the instruction signal shows the low level voltage, the instruction signal is instructing to turn on the power supply switch 30. The device control unit 67, in the case of determining that turning on the power supply switch 30 is not being instructed (S22: NO), executes step S22 again. The device control unit 67 waits until the voltage shown by the instruction signal switches from the high level voltage to the low level voltage.

The device control unit 67, in the case of determining that turning on the power supply switch 30 is being instructed by the instruction signal (S22: YES), determines whether turning on the power supply switch 30 is allowable, based on the vehicle information being input to the information input unit 61 (step S23). Assume that the load 12 is a motor that unlocks doors of the vehicle C, and the vehicle information indicates the speed of the vehicle C. In this case, when the speed indicated by the vehicle information is zero, for example, the device control unit 67 determines that turning on the power supply switch 30 is allowable. In the same case, when the speed indicated by the vehicle information exceeds zero, for example, the device control unit 67 determines that turning on the power supply switch 30 is not allowable.

The device control unit 67, in the case of determining that turning on the power supply switch 30 is allowable (S23: YES), instructs the device communication unit 60 to transmit the ON signal (step S24). The device communication unit 60 thereby transmits the ON signal to the IC communication unit 52 of the IPD 20, and the drive circuit 40 of the IPD 20 turns on the power supply switch 30. After executing step S24, the device control unit 67 changes the value of the state flag to 1 (step S25). The device control unit 67, in the case of determining that turning on the power supply switch 30 is not allowable (S23: NO), or after executing step S25, ends the transmission processing. After ending the transmission processing, the device control unit 67 executes the transmission processing again.

The device control unit 67, in the case of determining that the value of the state flag is not zero (S21: NO), determines whether turning off the power supply switch 30 is being instructed by the instruction signal (step S26). When the instruction signal shows the high level voltage, the instruction signal is instructing to turn off the power supply switch 30. The device control unit 67, in the case of determining that turning off the power supply switch 30 is not being instructed (S26: NO), executes step S26 again. The device control unit 67 waits until the voltage shown by the instruction signal switches from the low level voltage to the high level voltage.

The device control unit 67, in the case of determining that turning off the power supply switch 30 is being instructed by the instruction signal (S26: YES), determines whether turning off the power supply switch 30 is allowable, based on the vehicle information being input to the information input unit 61 (step S27). Assume that the load 12 is the headlights of the vehicle C, and the vehicle information indicates the speed of the vehicle C and the brightness around the vehicle C. In this case, for example, when the brightness indicated by the vehicle information is high, the device control unit 67 determines that turning off the power supply switch 30 is allowable regardless of the speed of the vehicle C. In the same case, when the speed of the vehicle C exceeds zero and the brightness indicated by the vehicle information is low, for example, the device control unit 67 determines that turning off the power supply switch 30 is not allowable.

The device control unit 67, in the case of determining that turning off the power supply switch 30 is allowable (S27: YES), instructs the device communication unit 60 to transmit the OFF signal (step S28). The device communication unit 60 thereby transmits the OFF signal to the IC communication unit 52 of the IPD 20, and the drive circuit 40 of the IPD 20 turns off the power supply switch 30. After executing step S28, the device control unit 67 changes the value of the state flag to zero (step S29). The device control unit 67, in the case of determining that turning off the power supply switch 30 is not allowable (S27: NO), or after executing step S29, ends the transmission processing. After ending the transmission processing, the device control unit 67 executes the transmission processing again.

As described above, when the instruction signal instructs to turn on the power supply switch 30, the device communication unit 60 transmits the ON signal to the IC communication unit 52 of the IPD 20. The drive circuit 40 thereby turns on the power supply switch 30. When the instruction signal instructs to turn off the power supply switch 30, the device communication unit 60 transmits the OFF signal to the IC communication unit 52 of the IPD 20. The drive circuit 40 thereby turns off the power supply switch 30.

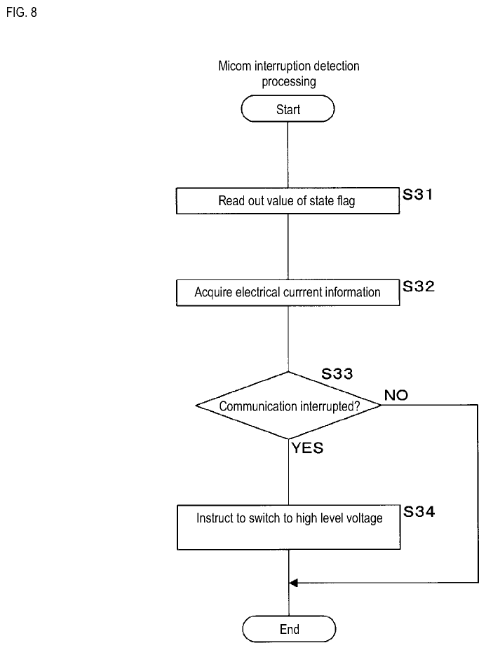

FIG. 8 is a flowchart showing the procedure of interruption detection processing. The device control unit 67 executes the interruption detection processing while the backup circuit 22 is outputting the low level voltage to the IC input unit 51 of the IPD 20. In the interruption detection processing, the device control unit 67, first, reads out the value of the state flag (step S31) and acquires electric current information from the A/D conversion unit 62 (step S32). Acquiring the electric current information is equivalent to acquiring the value of the switch current. Next, the device control unit 67 determines whether communication via the communication line Lc is interrupted, based on the value of the state flag read out in step S31 and the switch current indicated by the electric current information acquired in step S32 (step S33).

The determination of step S33 in the case where the value of the state flag read out in step S31 is zero will now be described. As aforementioned, in the transmission processing, the device control unit 67, in the case of having instructed the device communication unit 60 to transmit the OFF signal, changes the value of the state flag to zero. In the case where communication via the communication line Lc is not interrupted, the power supply switch 30 is off when the value of the state flag is zero. When the power supply switch 30 is off, the switch current that flows through the power supply switch 30 is zero A.

In step S33, the device control unit 67 determines that communication is not interrupted, if the switch current indicated by the electric current information acquired in step S32 is less than a fixed first current threshold. The first current threshold is a positive value near zero A. The device control unit 67 determines that communication is interrupted, if the switch current indicated by the electric current information acquired in step S32 is greater than or equal to the first current threshold despite the value of the state flag being zero. The IC communication unit 52 of the IPD 20 is regarded as having not received the OFF signal. The first current threshold corresponds to the second predetermined current.

The determination of step S33 in the case where the value of the state flag read out in step S31 is 1 will now be described. As aforementioned, in the transmission processing, the device control unit 67, in the case of having instructed the device communication unit 60 to transmit the ON signal, changes the value of the state flag to 1. In the case where communication via the communication line Lc is not interrupted, the power supply switch 30 is on when the value of the state flag is 1. When the power supply switch 30 is on, the switch current that flows through the power supply switch 30 is relatively large.

In step S33, the device control unit 67 determines that communication is not interrupted, if the switch current indicated by the electric current information acquired in step S32 is greater than or equal to a fixed second current threshold. The second current threshold is a positive value near zero A. The second current threshold may be the same as or different from the first current threshold. The device control unit 67 determines that communication is interrupted, if the switch current indicated by the electric current information acquired in step S32 is less than the second current threshold despite the value of the state flag being 1. The IC communication unit 52 of the IPD 20 is regarded as having not received the ON signal.

As described above, the device control unit 67 detects that communication via the communication line Lc is interrupted, based on the value of the state flag and the switch current.

The device control unit 67, in the case of determining that communication is not interrupted (S33: NO), ends the interruption detection processing. In this case, the device control unit 67 executes the interruption detection processing again. The device control unit 67, in the case of determining that communication is interrupted (S33: YES), instructs the voltage output unit 63 to switch the voltage being output to the backup circuit 22 by the voltage output unit 63 from the low level voltage to the high level voltage (step S34).

After executing step S34, the device control unit 67 ends the interruption detection processing. In this case, the device control unit 67 does not execute the interruption detection processing again. Furthermore, the device control unit 67 stops executing the transmission processing.

Because the IC communication unit 52 of the IPD 20 does not receive a signal when communication via the communication line Lc is interrupted, the IC control unit 54 of the IPD 20 changes the value of the communication flag to zero. When the instruction signal is instructing to turn on the power supply switch 30 in the case where the voltage output unit 63 of the MICOM 21 is outputting the high level voltage to the backup circuit 22, the backup circuit 22 outputs the high level voltage. When the instruction signal is instructing to turn off the power supply switch 30 in the same case, the backup circuit 22 outputs the low level voltage.

The drive circuit 40 of the IPD 20 turns on the power supply switch 30, when the output voltage of the backup circuit 22 switches from the low level voltage to the high level voltage. The drive circuit 40 of the IPD 20 turns off the power supply switch 30, when the output voltage of the backup circuit 22 switches from the high level voltage to the low level voltage.

As described above, the backup circuit 22 switches the output voltage to the high level voltage or the low level voltage, based on the instruction signal. The backup circuit 22 instructs the drive circuit 40 to turn off the power supply switch 30 by switching the output voltage to the high level voltage, and instructs the drive circuit 40 to turn on the power supply switch 30 by switching the output voltage to the low level voltage. When the device control unit 67 executes step S34, the backup circuit 22 starts instructing to turn the power supply switch 30 on or off. The backup circuit 22 functions as an instruction circuit.

The device control unit 67 executes different processing from the output processing, transmission processing and interruption detection processing. For example, if the device communication unit 60 has not performed transmission via the communication line LC for a fixed period shorter than the predetermined time period relating to the flag change processing, the device control unit 67 instructs the device communication unit 60 to transmit a dummy signal to the IC communication unit 52 of the IPD 20. In this case, the IC communication unit 52 of the IPD 20 receives a signal at a shorter time interval than the predetermined time period, until communication via the communication line Lc is interrupted or the MICOM 21 stops operating. When the IC communication unit 52 receives the dummy signal, processing based on the received dummy signal is not executed. The IC control unit 54 discards the received dummy signal.

### Configuration of Backup Circuit 22

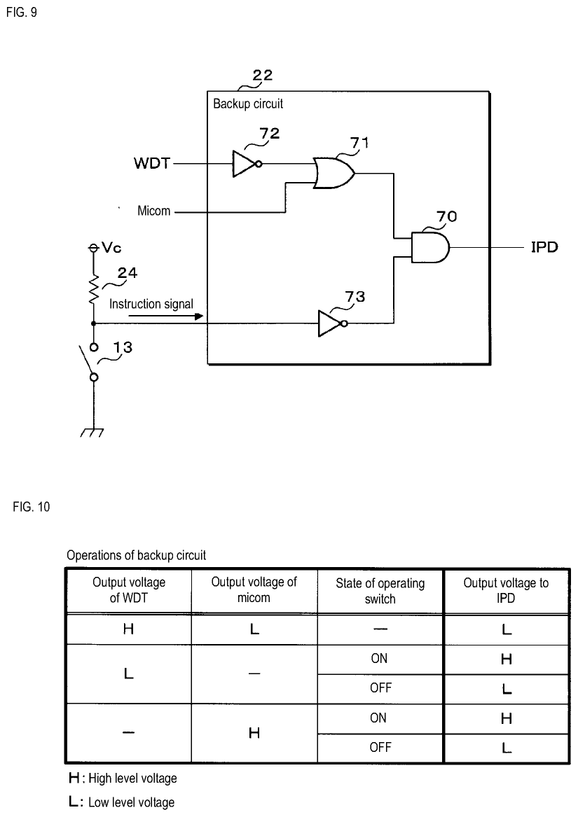

FIG. 9 is a circuit diagram of the backup circuit 22. The backup circuit 22 includes an AND circuit 70, an OR circuit 71, a first inverter 72 and a second inverter 73. The AND circuit 70 and the OR circuit 71 each have two input ends and one output end. The first inverter 72 and the second inverter 73 each have one input end and one output end.

The output end of the AND circuit 70 is connected to the IC input unit 51 of the IPD 20. One input end of the AND circuit 70 is connected to the output end of the OR circuit 71. One input end of the OR circuit 71 is connected to the output end of the first inverter 72. The input end of the first inverter 72 is connected to the WDT 23. The other input end of the OR circuit 71 is connected to the voltage output unit 63 of the MICOM 21. The other input end of the AND circuit 70 is connected to the output end of the second inverter 73. The input end of the second inverter 73 is connected to the connection node between the device resistor 24 and the operating switch 13.

The first inverter 72 outputs the low level voltage to the OR circuit 71, when the output voltage of the WDT 23 is the high level voltage. The first inverter 72 outputs the high level voltage to the OR circuit 71, when the output voltage of the WDT 23 is the low level voltage. The OR circuit 71 outputs the low level voltage to the AND circuit 70, when both the first inverter 72 and the voltage output unit 63 are outputting the low level voltage. The OR circuit 71 outputs the high level voltage to the AND circuit 70, when at least one of the first inverter 72 and the voltage output unit 63 is outputting the high level voltage.

The second inverter 73 outputs the high level voltage to the AND circuit 70, when the voltage of the instruction signal is the low level voltage. The second inverter 73 outputs the low level voltage, when the voltage of the instruction signal is the high level voltage. The AND circuit 70 outputs the high level voltage to the IC input unit 51 of the IPD 20, when both the OR circuit 71 and the second inverter 73 are outputting the high level voltage. The AND circuit 70 outputs the low level voltage to the IC input unit 51 of the IPD 20, when at least one of the OR circuit 71 and the second inverter 73 is outputting the low level voltage.

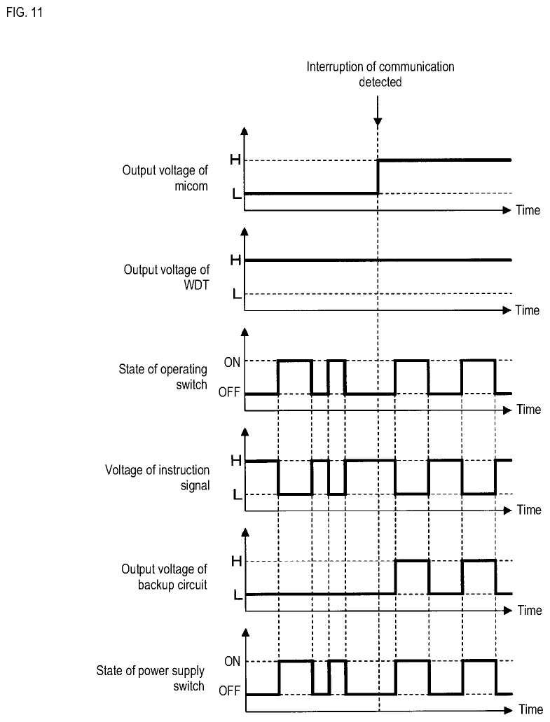

FIG. 10 is a chart showing operations of the backup circuit 22. When the WDT 23 and the voltage output unit 63 of the MICOM 21 are respectively outputting the high level voltage and the low level voltage, the OR circuit 71 outputs the low level voltage to the AND circuit 70. Thus, regardless of the state of the operating switch 13, that is, the voltage of the instruction signal, the AND circuit 70 outputs the low level voltage to the IC input unit 51 of the IPD 20.

When the WDT 23 is outputting the low level voltage, the OR circuit 71 outputs the high level voltage to the AND circuit 70 regardless of the output voltage of the voltage output unit 63 of the MICOM 21. In this case, the AND circuit 70 outputs the same voltage as the output voltage of the second inverter 73 to the IC input unit 51 of the IPD 20. Accordingly, when the operating switch 13 is on, the AND circuit 70 outputs the high level voltage. When the operating switch 13 is off, the AND circuit 70 outputs the low level voltage. As aforementioned, when the operating switch 13 is on, the instruction signal shows the low level voltage. When the operating switch 13 is off, the instruction signal shows the high level voltage.

When the voltage output unit 63 of the MICOM 21 is outputting the high level voltage, the OR circuit 71 outputs the high level voltage to the AND circuit 70 regardless of the output voltage of the WDT 23. In this case, the AND circuit 70 outputs the same voltage as the output voltage of the second inverter 73 to the IC input unit 51 of the IPD 20. Accordingly, when the operating switch 13 is on, the AND circuit 70 outputs the high level voltage. When the operating switch 13 is off, the AND circuit 70 outputs the low level voltage.

FIG. 11 is a timing chart showing a first example of operations performed by the power supply control device 10. FIG. 11 shows transitions of the output voltage of the voltage output unit 63 of the MICOM 21, the output voltage of the WDT 23, the state of the operating switch 13, the voltage of the instruction signal, the output voltage of the backup circuit 22, and the state of the power supply switch 30. The horizontal axes of these transitions show time. To simplify description, it is assumed that turning the power supply switch 30 on or off is not prohibited, based on the vehicle information. H indicates the high level voltage. L indicates the low level voltage.

As aforementioned, when the operating switch 13 is on, the instruction signal shows the low level voltage and instructs to turn on the power supply switch 30. When the operating switch 13 is off, the instruction signal shows the high level voltage and instructs to turn off the power supply switch 30.

As aforementioned, when the MICOM 21 is operating and communication via the communication line Lc is not interrupted, the voltage output unit 63 of the MICOM 21 and the WDT 23 respectively output the low level voltage and the high level voltage. The backup circuit 22 thus outputs the low level voltage to the IC input unit 51 of the IPD 20. Accordingly, when the operating switch 13 turns on, the device communication unit 60 of the MICOM 21 outputs the ON signal, and the drive circuit 40 of the IPD 20 turns on the power supply switch 30. When the operating switch 13 turns off, the device communication unit 60 of the MICOM 21 outputs the OFF signal, and the drive circuit 40 of the IPD 20 turns off the power supply switch 30.

In the MICOM 21, when the IC control unit 54 detects interruption of communication, the voltage output unit 63 switches the output voltage from the low level voltage to the high level voltage. When the voltage output unit 63 is outputting the high level voltage, the AND circuit 70 of the backup circuit 22 outputs a voltage that depends on the voltage of the instruction signal. When the voltage of the instruction signal is the low level voltage, the AND circuit 70 outputs the high level voltage. When the voltage of the instruction signal is the high level voltage, the AND circuit 70 outputs the low level voltage.

Because a signal is not received by the IC communication unit 52 for greater than or equal to a predetermined time period when communication via the communication line Lc is interrupted, the IC control unit 54 changes the value of the communication flag to zero. The drive circuit 40 of the IPD 20 thus turns the power supply switch 30 on or off, according to the output voltage of the backup circuit 22. As described above, even if communication via the communication line LC is interrupted, the drive circuit 40 of the IPD 20 turns the power supply switch 30 on or off, according to the instruction content of the instruction signal.

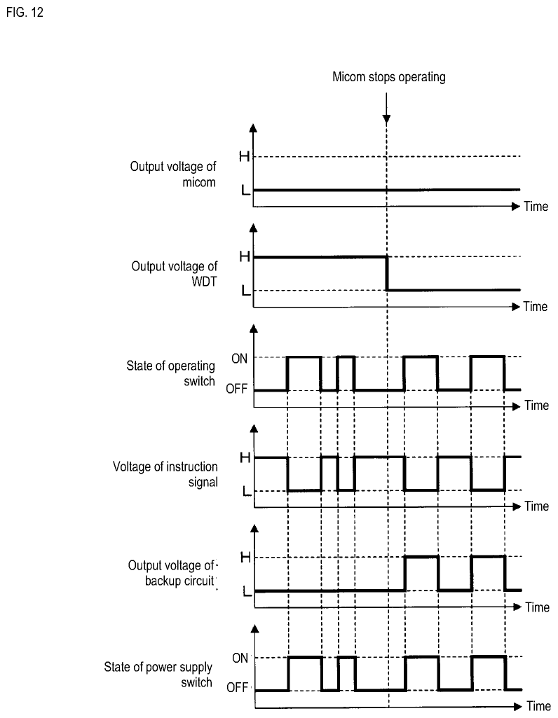

FIG. 12 is a timing chart showing a second example of operations performed by the power supply control device 10. FIG. 12, similarly to FIG. 11, shows transitions of the output voltage of the voltage output unit 63 of the MICOM 21, the output voltage of the WDT 23, the state of the operating switch 13, the voltage of the instruction signal, the output voltage of the backup circuit 22, and the state of the power supply switch 30. The horizontal axes of these transitions show time. In the description of the second example, it is assumed that turning the power supply switch 30 on or off is not prohibited, based on the vehicle information. H indicates the high level voltage. L indicates the low level voltage.

As aforementioned, when the MICOM 21 is operating and communication via the communication line Lc is not interrupted, the drive circuit 40 of the IPD 20 turns the power supply switch 30 on or off, according to the signal transmitted by the device communication unit 60 of the MICOM 21.

The WDT 23, in the case of determining that the MICOM 21 (device control unit 67) has stopped operating, switches the output voltage from the high level voltage to the low level voltage. When the WDT 23 switches the output voltage from the high level voltage to the low level voltage, the AND circuit 70 of the backup circuit 22 outputs a voltage that depends on the voltage of the instruction signal. When the voltage of the instruction signal is the low level voltage, the AND circuit 70 outputs the high level voltage. When the voltage of the instruction signal is the high level voltage, the AND circuit 70 outputs the low level voltage.

Since a signal is not received by the IC communication unit 52 for greater than or equal to a predetermined time period when the MICOM 21 (device control unit 67) stops operating, the IC control unit 54 changes the value of the communication flag to zero. The drive circuit 40 of the IPD 20 thus turns the power supply switch 30 on or off, according to the output voltage of the backup circuit 22.

As described above, when the WDT 23 switches the output voltage from the high level voltage to the low level voltage, the backup circuit 22 starts instructing to turn the power supply switch 30 on or off. Accordingly, even if the MICOM 21 stops operating, the drive circuit 40 of the IPD 20 turns the power supply switch 30 on or off, according to the instruction content of the instruction signal.

### Embodiment 2

In Embodiment 1, the device control unit 67 of the MICOM 21 detects that communication via the communication line Lc is interrupted, based on the value of the state flag and the switch current that flows through the power supply switch 30. The device control unit 67 may, furthermore, detect interruption of communication by another method.

Hereinafter, the differences of Embodiment 2 from Embodiment 1 will be described. Since the configuration other than that described below is common to Embodiment 1, components common to Embodiment 1 will be given the same reference numerals as Embodiment 1, and description thereof will be omitted.

### Configuration of Power Supply Control Device 10

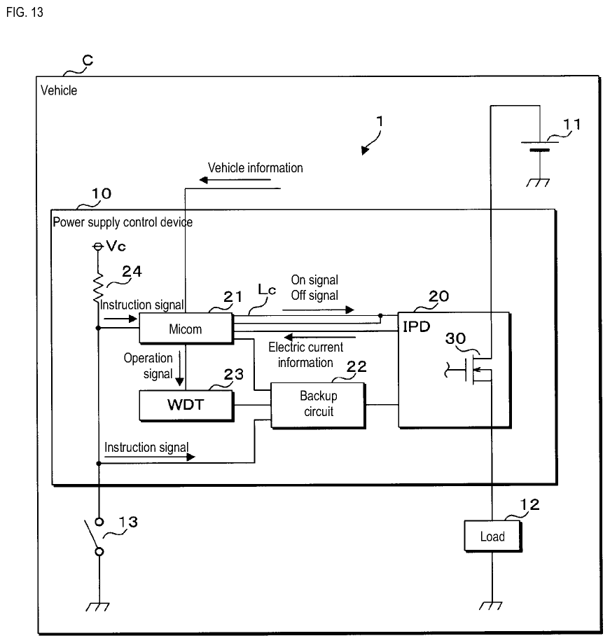

FIG. 13 is a block diagram showing the configuration of a main section of a power supply control device 10 according to Embodiment 2. In the power supply control device 10 of Embodiment 2, a connection node on a communication line Lc disposed on a switch board Bs is connected to a MICOM 21. The MICOM 21 detects the voltage of the communication line Lc. Similarly to Embodiment 1, the MICOM 21 detects interruption of communication, based on the value of the state flag and the switch current. Furthermore, the MICOM 21 detects interruption of communication, based on whether the voltage of the communication line Lc matches the voltage of the transmitted signal.

When disconnection occurs between the MICOM 21 and the connection node, communication via the communication line Lc is interrupted. The MICOM 21 detects interruption of communication caused by this disconnection, based on the voltage of the communication line Lc. The MICOM 21, in the case of detecting interruption of communication, switches the output voltage being output to the backup circuit 22 from the low level voltage to the high level voltage, similarly to Embodiment 1.

### Configuration of MICOM 21

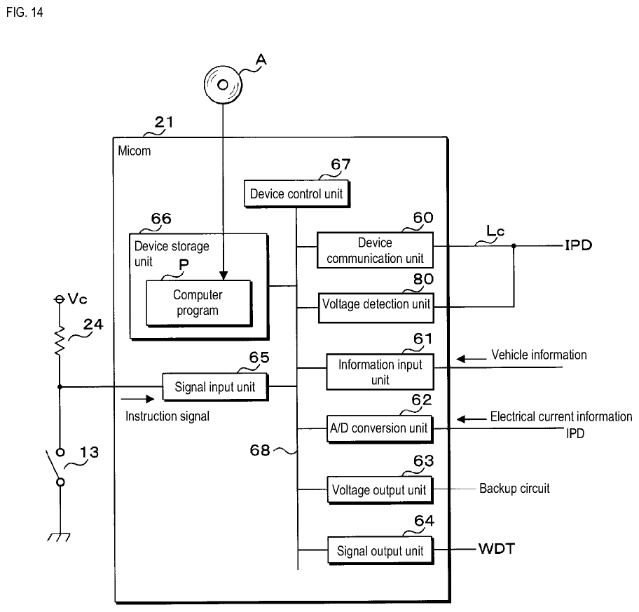

FIG. 14 is a block diagram showing the configuration of a main section of the MICOM 21. The MICOM 21 of Embodiment 2 further includes a voltage detection unit 80, in addition to the components provided in the MICOM 21 of Embodiment 1. The voltage detection unit 80 is connected to a device bus 68 and a connection node on the communication line Lc.

The voltage detection unit 80 detects the voltage of the communication line Lc that is disposed on the switch board Bs. The voltage detection unit 80 converts the detected analog voltage into a digital voltage. The value of the digital voltage obtained through conversion is acquired by the device control unit 67.

A processing element (computer) of the device control unit 67 further executes second interruption detection processing by executing a computer program P. The second interruption detection processing is processing for detecting interruption of communication via the communication line Lc, based on the voltage detected by the voltage detection unit 80.

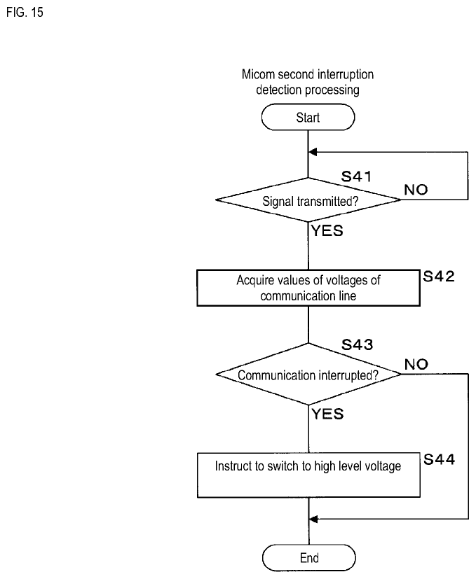

FIG. 15 is a flowchart showing the procedure of the second interruption detection processing. The device control unit 67 executes the second interruption detection processing while the backup circuit 22 is outputting the low level voltage to the IC input unit 51 of the IPD 20. In the second interruption detection processing, the device control unit 67, first, determines whether the device communication unit 60 has started performing signal transmission (step S41). The device control unit 67, in the case of determining that the device communication unit 60 has not started performing signal transmission (S41: NO), executes step S41 again. The device control unit 67 waits until the device communication unit 60 starts performing signal transmission.

The device control unit 67, in the case of determining that the device communication unit 60 has started performing signal transmission (S41: YES), acquires the values of the voltages of the communication line Lc detected by the voltage detection unit 80 while the device communication unit 60 is performing signal transmission (step S42). Next, the device control unit 67 determines whether communication via the communication line Lc is interrupted, based on the values of the voltages of the communication line Lc acquired in step S42 and the voltages of the signal transmitted by the device communication unit 60 (step S43).

In step S43, the device control unit 67 determines that communication via the communication line Lc is interrupted, if the values of the voltages of the communication line Lc acquired in step S42 do not match the voltage of the signal transmitted by the device communication unit 60. The device control unit 67 detects interruption of communication. If the values of the voltages of the communication line Lc acquired in step S42 match the voltage of the signal transmitted by the device communication unit 60, the device control unit 67 determines that communication via the communication line Lc is not interrupted.

The device control unit 67, in the case of determining that communication is not interrupted (S43: NO), ends the second interruption detection processing. In this case, the device control unit 67 executes the second interruption detection processing again. The device control unit 67, in the case of determining that communication is interrupted (S43: YES), instructs the voltage output unit 63 to switch the voltage being output to the backup circuit 22 by the voltage output unit 63 from the low level voltage to the high level voltage (step S44).

After executing step S44, the device control unit 67 ends the second interruption detection processing. In this case, the device control unit 67 does not execute the second interruption detection processing again. Furthermore, the device control unit 67 also stops executing the transmission processing and the interruption detection processing.

When communication via the communication line Lc is interrupted, the IC control unit 54 of the IPD 20 changes the value of the communication flag to zero. When the voltage output unit 63 switches the voltage being output to the backup circuit 22 from the low level voltage to the high level voltage, the backup circuit 22 switches the output voltage to the high level voltage or the low level voltage, based on an instruction signal, similarly to Embodiment 1. The drive circuit 40 of the IPD 20 turns the power supply switch 30 on or off, according to the output voltage of the backup circuit 22.

The power supply control device 10 of Embodiment 2 similarly achieves the effects that are achieved by the power supply control device 10 of Embodiment 1.

### Modifications of Embodiments 1 and 2

In Embodiments 1 and 2, the device control unit 67 detects that communication via the communication line Lc is interrupted, based on the value of the state flag and the switch current that flows through the power supply switch 30. A different value from the switch current may be used, when the device control unit 67 detects interruption of communication. The device control unit 67 may, for example, detect interruption of communication based on the voltage of the source of the power supply switch 30, instead of the switch current. The reference potential of the voltage of the source is ground potential.

When the power supply switch 30 is off, the voltage of the source of the power supply switch 30 is zero V. When the power supply switch 30 is on, the voltage of the source of the power supply switch 30 is the end-to-end voltage of the DC power source 11. The device control unit 67 detects interruption of communication, when the voltage of the source of the power supply switch 30 is greater than or equal to a fixed first voltage despite the value of the state flag being zero. The device control unit 67 detects interruption of communication, when the voltage of the source of the power supply switch 30 is less than a fixed second voltage despite the value of the state flag being 1. The first voltage and the second voltage are each a positive value near zero V. The first voltage may be the same as or different from the second voltage.

The power supply switch 30 need only function as a switch. The power supply switch 30 is thus not limited to an N-channel FET, and may be a P-channel FET, a bipolar transistor or the like. The instruction signal is not limited to a signal that is output from the connection node between the device resistor 24 and the operating switch 13, and may be, for example, a signal that is output by an electrical device not shown installed in the vehicle C.

Embodiments 1 and 2 disclosed herein are considered in all respects to be illustrative and not restrictive. The scope of the disclosure is indicated by the claims rather than by the foregoing description, and all changes that come within the meaning and range of equivalency of the claims are intended to be embraced therein.

1. A power supply control device for controlling power supplied via a power supply switch, comprising:
a switcher configured to turn the power supply switch on or off;
an instruction circuit configured to instruct the switcher to turn the power supply switch on or off, based on an instruction signal instructing to turn the power supply switch on or off;
a communication unit configured to transmit an ON signal instructing to turn on the power supply switch and an OFF signal instructing to turn off the power supply switch to the switcher via a communication line; and
a processing unit configured to execute processing,
wherein the processing unit
instructs the communication unit to transmit the ON signal or the OFF signal, based on the instruction signal,
determines whether communication via the communication line is interrupted, and
in a case of determining that the interruption has occurred, causes the instruction circuit to start instructing to turn the power supply switch on or off.

2. The power supply control device according to claim 1, further including;
an operation determination unit configured to determine whether the processing unit has stopped operating,
wherein the operation determination unit, in the case of determining that the processing unit has stopped operating, causes the instruction circuit to start instructing to turn the power supply switch on or off.

3. The power supply control device according to claim 1,
wherein the processing unit
acquires a value of a switch current flowing through the power supply switch, and
if the acquired value of the switch current is less than a predetermined current value despite the communication unit being instructed to transmit the ON signal, determines that the interruption has occurred.

4. The power supply control device according to claim 1,
wherein the processing unit
acquires a value of a switch current flowing through the power supply switch, and
if the acquired value of the switch current is greater than or equal to a second predetermined current value despite the communication unit being instructed to transmit the OFF signal, determines that the interruption has occurred.

5. The power supply control device according to claim 1, further comprising including;
a voltage detection unit configured to detect a voltage of the communication line,
wherein the communication unit is disposed on a first board,
the switcher and part of the communication line are disposed on a second board,
the voltage detection unit detects the voltage of the communication line disposed on the second board, and
the processing unit determines whether the interruption has occurred, based on the voltage of the communication line detected by the voltage detection unit.

6. A power supply control method of a power supply control device for controlling power supplied via a power supply switch for use in controlling power supply and including a switcher configured to turn the power supply switch on or off, an instruction circuit configured to instruct the switcher to turn the power supply switch on or off based on an instruction signal instructing to turn the power supply switch on or off, and a communication unit configured to transmit an ON signal instructing to turn on the power supply switch and an OFF signal instructing to turn off the power supply switch to the switcher via a communication line, the power supply control method using a computer to execute:
instructing the communication unit to transmit the ON signal or the OFF signal, based on the instruction signal;
determining whether communication via the communication line is interrupted; and
in a case of determining that the interruption has occurred, causing the instruction circuit to start instructing to turn the power supply switch on or off.

7. The power supply control device according to claim 2,
wherein the processing unit
acquires a value of a switch current flowing through the power supply switch, and
if the acquired value of the switch current is greater than or equal to a second predetermined current value despite the communication unit being instructed to transmit the OFF signal, determines that the interruption has occurred.

8. The power supply control device according to claim 3,
wherein the processing unit
acquires a value of a switch current flowing through the power supply switch, and
if the acquired value of the switch current is greater than or equal to a second predetermined current value despite the communication unit being instructed to transmit the OFF signal, determines that the interruption has occurred.

9. The power supply control device according to claim 2, further including;
a voltage detection unit configured to detect a voltage of the communication line,
wherein the communication unit is disposed on a first board,
the switcher and part of the communication line are disposed on a second board,
the voltage detection unit detects the voltage of the communication line disposed on the second board, and
the processing unit determines whether the interruption has occurred, based on the voltage of the communication line detected by the voltage detection unit.

10. The power supply control device according to claim 3, further including;
a voltage detection unit configured to detect a voltage of the communication line,
wherein the communication unit is disposed on a first board,
the switcher and part of the communication line are disposed on a second board,
the voltage detection unit detects the voltage of the communication line disposed on the second board, and
the processing unit determines whether the interruption has occurred, based on the voltage of the communication line detected by the voltage detection unit.

11. The power supply control device according to claim 4, further including;
a voltage detection unit configured to detect a voltage of the communication line,
wherein the communication unit is disposed on a first board,
the switcher and part of the communication line are disposed on a second board,
the voltage detection unit detects the voltage of the communication line disposed on the second board, and
the processing unit determines whether the interruption has occurred, based on the voltage of the communication line detected by the voltage detection unit.
